(19) United States
(12) Patent Application Publication
(10) Pub. No.: US 2022/0127868 A1
(43) Pub. Date: Apr. 28, 2022

(54) MULTI-SPORT CENTER WITH COOLING AND HEATING SYSTEM

(71) Applicants: Byoungkoo CHO, Yeoju-si (KR); Yeonuk JEONG, Seoul (KR); Bosub KIM, Daegu (KR)

(72) Inventors: Byoungkoo CHO, Yeoju-si (KR); Yeonuk JEONG, Seoul (KR); Bosub KIM, Daegu (KR)

(21) Appl. No.: 17/330,205

(22) Filed: May 25, 2021

(30) Foreign Application Priority Data
Oct. 23, 2020 (KR) 10-2020-0138571

(51) Int. Cl. E04H 3/14; A63C 19/08

(52) U.S. Cl. CPC E04H 3/14; A63C 2019/085; A63C 19/08

(57) ABSTRACT

The present invention relates to a multi-sport center and more specifically, a multi-sport center having sectors used for various sport games and a passage separating the sectors, wherein each sector includes courts formed according to court standards of sports whose courts are inter-compatible to each other, and the adjacent courts are inter-compatible, thereby increasing efficiency of a sport center. The center further comprises more than one cooling and heating booth installed at one side of each sector, thereby helping players in each court to take breaks. In addition, the center further comprises cantilevers that is installed on an inner wall at the second to the fourth floor level and that can look down the first floor, wherein a café, a snack bar, a media room, an electronic game room, a go game room, and jogging track, instead of stands, are installed on the cantilevers.

### TECHNICAL FIELD

The invention relates to a multi-sport center an air-conditioning system and more particularly, a multi-sport center having sectors used for various sport games and a passage separating the sectors, wherein each sector includes courts formed according to court standards of: sports whose courts are inter-compatible to each other, and the adjacent courts are inter-compatible, thereby increasing efficiency of a sport center. In addition, the invention relates to a multi-sport center further comprising more than one cooling and heating booth installed at one side of each sector, thereby helping players in each court to take breaks. Furthermore, the invention relates to a multi-sport center further comprising cantilevers that is installed on an inner wall at the second to the fourth floor level and that can see the first floor, wherein a cafe, a snack bar, a media room, an electronic game room, a go game room, and jogging track, instead of stands, are installed on the cantilevers.

### BACKGROUND ART

As leisure time and an interest in health increase according to the economy development, the public begins to be interested in playing various sports other than popular sports such as soccer and basketball. Despite of this change in society, there are not many related facilities where people can easily access. Even though there are huge-size sport facilities for Olympic or World Cup, this is not for the public because they are constructed for specific sports and cannot be used for multiple sports due to constraints of the stadium structure. In addition, since the huge size sport facilities have stand in large quantities in the second, the third, and the fourth floor, a space for a sport facility is insufficient, and thus, it is difficult for the public to do exercise in this type of sport facilities. Recently, according to a study showing that adequate exercise is beneficial for learning, elementary, middle, and high schools encourage physical activities after school. Even though students' demands for physical activities increases, sport facilities for these demands are not enough. Therefore, multi-sport facilities for the public and students are urgently needed. Although gymnasiums of some middle and high schools, or community service centers have a badminton court or a basketball court, these also cannot be used for multiple sports due to constraints of court structures because these places are specialized for specific sports. As illustrated in FIG. 1, a basketball court is specialized for basketball. When there is no basketball game in the court, people try to use it for other sports by installing a badminton net in the middle of the court. However, due to a size difference between two sports, there is a wasted space B1-B2, and thus, it is inefficient in terms of practical space use. Accordingly, there is an urgent need for a new court design, which can be used for various sports.

Meanwhile, the cold of winter and the heat of summer makes it difficult to do exercise outside. Specifically, there are constraints for outdoor exercise for four months from December to March due to the cold and for another four months from June to September. Thus, more than half the year is inappropriate for exercise.

In addition, recently, yellow dust and fine dust have occurred throughout the year, and ultraviolet rays caused by ozone layer depletion is also a serious problem. As the environmental pollution is getting worse, it becomes more adverse environment for people, who are required more exercise or outdoor activities, such as the elderly, children, and physically weak people.

Accordingly, there is an indoor sport facility where people can do exercise indoors. However, the number of the indoor sport facility is too small, and thus, there are sometimes conflicts or accidents between people when they scramble for limited spaces. Therefore, there is an urgent need for expanding indoor sport facilities where people can do exercise freely. In addition, these indoor sport facilities are required to install a cooling and heating system for pleasant exercise in summer and winter. However, since the indoor sport facility has a huge space, an enormous amount of electricity is consumed to cool down and heat the entire space. When the indoor sport facility is not filled with people, cooling down and heating the entire space is a waste in terms of energy efficiency, and thus, the solution for this is required.

### DISCLOSURE

### Technical Problem

Accordingly, one object of the present invention is to provide a sport center having sectors used for various sport games and a passage separating the sectors, wherein each sector includes courts formed according to court standards of sports whose courts are inter-compatible to each other, and the adjacent courts are inter-compatible, thereby increasing efficiency of a sport center.

Another object of the present invention is to provide a sport center enabling adjacent courts to be inter-compatible by using a relation between a long direction boundary and a short direction boundary.

Another object of the present invention is to provide a sport center enabling compatible courts to have no wasted space, thereby increasing efficiency of space availability.

Another object of the present invention is to provide a sport center including a post, which divides a court, thereby enabling a court to change to another court quickly.

Another object of the present invention is to provide a sport center including posts, which are installed at certain positions, thereby enabling a court to change to another court quickly, efficiently.

Another object of the present invention is to provide a sport center including a division mean, which divides the court using posts, thereby enabling a court to change to another court quickly, efficiently.

Another object of the present invention is to provide a sport center including a cooling and heating booth, thereby enabling users to enjoy pleasant rest and increasing energy efficiency of the sport facility.

Another object of the present invention is to provide a sport center including a duct of the cooling and heating booth, which separates the sector, the court, or the passage from the other sector or court and prevents disturbance to a game.

Another object of the present invention is to provide a sport center including walls of the cooling and heating booth which is made of transparent materials, thereby enabling people to see a sport game from the inside of the booth during breaks.

Another object of the present invention is to provide a sport center including various facilities for general citizens

Another object of the present invention is to provide a sport center including jogging track on the upper floor, thereby enabling the sport center to be managed efficiently.

Another object of the present invention is to provide a sport center including recreational facilities on the upper floor, thereby enabling users to use the sport center conveniently.

### Technical Solution

According to one embodiment of the invention, a multi-sport center comprising: sectors used for various sport games, and a passage separating the sectors that are adjacent to each other, wherein each sector includes courts having court boundaries and partitioned for each sport, the court boundaries of each court is formed according to court standards of sports whose courts are inter-compatible to each other, and the courts that are adjacent to each other are inter-compatible, thereby increasing management efficiency of the multi-sport center.

According to another embodiment of the invention, the court boundaries include a long direction boundary and a short direction boundary that is shorter than the long direction boundary.

According to another embodiment of the invention, a long direction boundary of a first type court of a given court of the courts is formed to be an integer multiple of a short direction boundary of a second type court of the given court.

According to another embodiment of the invention, the courts further include posts installed along the long direction boundary to separate the courts.

According to another embodiment of the invention, the post includes: vertex posts installed at vertexes of each court, and middle posts installed along the long direction boundary at every point that forms integer multiples of a length of the short direction boundary of the second type.

According to another embodiment of the invention, the multi-sport center further comprising an engagement mean connecting between the middle posts each installed at the long direction boundaries that face to each other, thereby dividing the first type court into multiple subordinate courts, wherein the multiple subordinate courts formed by the engagement mean meet standard requirements of the second type court.

According to another embodiment of the invention, the multi-sport center further comprising more than one cooling and heating booth installed at one side of each sector and helping players in each court to take breaks.

According to another embodiment of the invention, the cooling and heating booth includes a duct, and the duct is mounted on the posts to avoid disturbance to a sport game.

According to another embodiment of the invention, the cooling and heating booth is made of transparent materials, thereby enabling people to see sport games from the inside of the booth.

According to another embodiment of the invention, the multi-sport center further comprising more than one cantilever overhung from an inner side of a wall surrounding a space where the sectors are located, wherein the cantilever is installed at a level that does not disturb sport games.

According to another embodiment of the invention, one side of the cantilever includes jogging track.

According to another embodiment of the invention, one side of the cantilever includes at least one of café, a snack bar, a theater, a media room, an electronic game room, a go game room, and a virtual experience room, thereby enabling family to spend a time together.

According to another embodiment of the invention, the multi-sport center further comprising image facilities that display images or videos with 75% to 85% transparency on an inner side or an outer side of the wall of the booth, wherein the image facilities display: images or videos including scenes that a coach analyzes and watches a sport game in the court, or coaches players of the game in real time, images or videos of the game that is filmed until before the game is stopped, and images or videos of substitute players for the game and instant replays of the game in real time.

According to another embodiment of the invention, the court includes a top side, a bottom side, a left side, and a right side, wherein a center boundary divides the court in the center, the center boundary is formed to be parallel to the short direction boundary, and includes a first side facing the top side of the court and a second side facing the bottom side of the court, wherein at least one roll screen module that is spread out from a top to a bottom is installed on the top side, the bottom side, the left side, the right side, the first side, and the second side.

According to another embodiment of the invention, the screen module displays scenes including a coach giving demonstrations or instructions using high quality images or video, 3D images or videos, or hologram image or videos, as necessary.

According to another embodiment of the invention, the roll screen module is hung on and fixed to more than one vertex post or/and more than one middle post and has a net shape.

According to another embodiment of the invention, when the hologram images or videos are displayed, more than one rail, on which the roll screen module is mounted, is installed on the inner side or the outer side of the wall, and the rail is installed to be parallel and face to each other on both sides of a center of the booth.

### Advantageous Effects

The present invention has technical effect by embodiments mentioned above, components, and connections described as following.

The present invention can provide a sport center having sectors used for various sport games and a passage separating the sectors, wherein each sector includes courts formed according to court standards of sports whose courts are inter-compatible to each other, thereby increasing efficiency of a sport center and providing a space where general citizens can enjoy various sport games.

The present invention can provide a sport center enabling adjacent courts to be inter-compatible by using a relation between a long direction boundary and a short direction boundary. Accordingly, users can find an appropriate court that they want to use.

The present invention can provide a sport center enabling compatible courts to have no wasted space, thereby increasing efficiency of space availability.

The present invention can provide a sport center including a post, which divides a court, thereby enabling users to change the court type and use it in various ways according to their inventions.

The present invention can provide a sport center including posts, which are installed at certain positions, thereby enabling users to change the court type quickly, efficiently.

The present invention can provide a sport center including a division mean, which divides the court using posts, thereby enabling users to concentrate on his game without being disturbed from adjacent courts.

The present invention can provide a sport center including a cooling and heating booth, thereby enabling users to enjoy pleasant rest, increasing energy efficiency of the sport facility, and saving cost and energy.

The present invention can provide a sport center including a duct of the cooling and heating booth, which separates the sector, the court, or the passage from the other sector or court, thereby minimizing disturbance to a game.

The present invention can provide a sport center including walls of the cooling and heating booth which is made of transparent materials, thereby enabling people to see a sport game from the inside of the booth during breaks.

The present invention can provide a sport center including cantilevers where various facilities for general citizens can be installed, thereby increasing convenience of users.

The present invention can provide a sport center including jogging track in one side of the cantilever, thereby maximizing space availability and providing pleasant surroundings for joggers.

The present invention can provide a sport center including a café, a snack bar, and a media room in one side of the cantilever, thereby enabling users to take comfortable rests and use the sport center conveniently.

### DESCRIPTION OF DRAWINGS

FIG. 1 is a perspective view of an indoor sport facility according to prior inventions.

FIG. 2 is a perspective view of an indoor sport facility according to one embodiment of prior inventions.

FIG. 3 is a perspective view of a multi-sport facility according to the present invention.

FIG. 4 is a magnified perspective view of a court according to the present invention.

FIG. 5 is a magnified perspective view showing partitions in a court according to the present invention.

FIG. 6 is a perspective view of a cooling and heating booth according to the present invention.

FIG. 7 is a perspective view showing a cooling and heating booth and a duct according to the present invention.

FIG. 8 is a cross-sectional view of a multi-sport facility according to the present invention.

FIG. 9 is a perspective view of a post and a division mean according to the present invention.

FIG. 10 is a perspective view of a booth according to one embodiment of the present invention.

FIG. 11 is a perspective view of a multi-sport facility according to one embodiment of the present invention.

FIG. 12 is a perspective view of a booth according to another embodiment of the present invention.

### MODE FOR INVENTION

Hereinafter, some embodiments of the present invention will be described in detail in conjunction with the accompanying drawings. In this process, a thickness of lines or a size of components illustrated in drawings may be exaggerated for clarity.

In addition, all terms used herein is defined considering functions in the present invention and may be varied depending on an intention of a user, or an operator, or the meaning as commonly understood by one of ordinary skill in the art to which this disclosure most closely pertains. Therefore, those terminologies shall be defined based on the entire description.

Embodiments of the present invention described above are to be considered illustrative, and the scope of the present invention shall not be restricted or limited by the foregoing description. The present invention may be varied or modified, and the appended claims are intended to cover all such modifications, enhancements, and other embodiments, which fall within the true spirit and scope of the inventive concept.

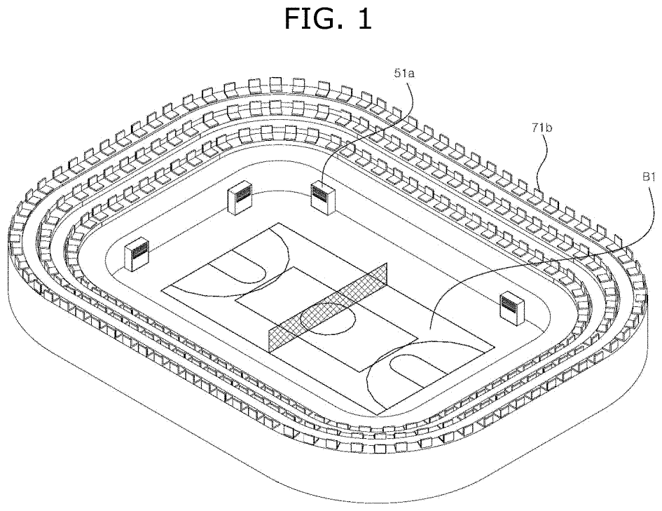

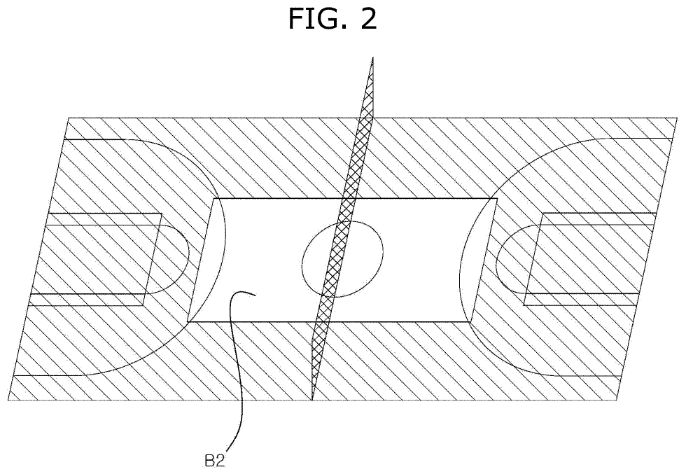

FIG. 1 is a perspective view of an indoor sport facility according to prior inventions. A basketball court B1 is located in the center, and stands are formed to surround the court B1 on the second floor 71b. Since the court is designed for basketball, it is difficult to use the court for other sport games even if there is no basketball game in the court. As illustrated in FIG. 2, a basketball court is sometimes used for other sports by installing a badminton net in the middle of the court. However, due to a size difference between the courts of these two sports, a large space can be wasted (The hatched part in FIG. 2, B1-B2). Accordingly, even if people want to use those sport facilities for other sports, it is hardly accessible due to space constraints.

The sport facilities for huge games such as FIG. 1 are equipped with stands 71b in large quantities on the upper level portion of the facilities. In contrast, sport facilities for general citizens do not require such stands, and the stands are even a hindrance for player who do exercise.

In addition, the sport facilities such as FIG. 1 have a large scale air-conditioning device 51a for indoor cooling and heating, but it requires an enormous electricity to cope with the huge space of the sport facility. Since the sport facility is not always filled with people, turning on the air-conditioning device only for a small number of people would be an energy waste. A passive house or a facility using IOT could save an energy, but those facilities are not widely used due to high initial costs.

According to the invention, sectors include courts having court boundaries and partitioned for each sport, and each court is formed according to court standards of sports whose courts are inter-compatible to each other.

Specifically, a multi-sport center according to the present invention may comprise at least one of the sector 1, and the sector 1 is described as a first sector 11, a second sector 12, . . . , a n sector 1n (n>=1). The sectors are spaced apart from each other with a certain distance and comprises a passage 3 therebetween. Using the passage 3, users of the center can easily access to the sector 1 that they want to use. With these multiple sectors, the multi-sport center according to the invention enables various kinds of sports to be played, thereby enabling general citizens to enjoy various exercises.

For example, the inside of the first sector 11 of the sectors 1 may comprise courts 111, 113, . . . , 11m, which have court boundary partitioning for each sport (m>=1). In this instance, the court boundary of each court is formed according to court standards of sports whose courts are inter-compatible to each other, and neighboring courts can be compatible with each other, thereby increasing efficiency of the sport center management.

In this instance, sports that can be compatible with each other in one court may be various. For example, futsal and tennis can be compatible with each other because the sizes of their courts are the same. Foot volleyball, basketball, and volleyball can also be compatible with each other because the sizes of their courts are similar. Any other sports whose court standards are similar to each other can be compatible.

Specifically, the compatible courts are disposed in neighboring areas of one sector 1, and two games, which are different kinds of sports (For example, tennis and futsal), are played in the neighboring areas, respectively. In this instance, one of the two games may be converted its sport type to the same sport type as that of the other of the two game, thereby enabling the two games of the same sport type to be played in neighboring areas at the same time. In this case, a spectator, who want to see games of a specific sport, can conveniently enjoy a plurality of games in one seat.

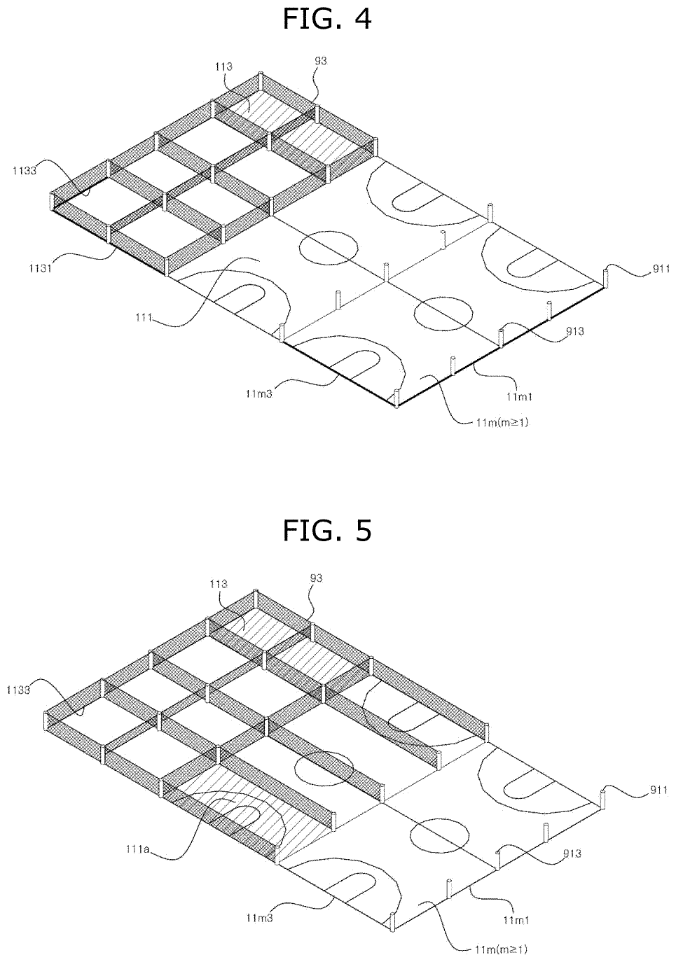

Hereafter, referring to FIGS. 4 and 5, a method for partitioning one court into multiple smaller courts will be explained. The courts 111, 113, . . . , 11m may have a rectangular shape, including a long direction boundary 11m1 and a short direction boundary 11m3, which is shorter than the long direction boundary 11m1. Courts of most sports do not have square shapes, and the rectangular shape has advantageous effects in terms of inter-compatibility.

Hereafter, for convenient explanation, two courts 111, 113 will be used to describe the invention. A first type court 111 may have a bigger area than that of a second type court 113. In this case, a long direction boundary 11m1 of the first type court 111 may be formed to be approximately an integer multiple of a short direction boundary 1133 of the second type court 113. In this case, the first type court 111 may be divided into multiple subordinate courts, and an area size of this subordinate court 111a is the same as an area size of the second type court 113. Accordingly, the first type court 111 can be divided into multiple the second type court 113, thereby enabling different sports with different court sizes to be played using the same space.

In addition, since a length of the long direction boundary is formed to be an integer multiple of a length of the short direction boundary, the first type court 111 can be divided into multiple subordinate court 111a without a wasted space. Accordingly, the multi-sport center, which maximizes efficiency of space availability, has advantageous effects when compared to prior art in FIGS. 1 and 2. As mentioned above, it is desired that a long direction boundary 11m1 of the first type court 111 may be formed to be approximately an integer multiple of a short direction boundary 1133 of the second type boundary 113. This structure is shown in FIG. 4.

The first type court 111 can be divided in various ways other than quarters. Thus, the division of the first type court 111 can be applied to any sport whose boundary length of a court has an integer multiple relation with the boundary length of the first type court 111. Thus, as long as a condition, which a long direction boundary 11m1 of the first type court 111 is an integer multiple of a short direction boundary 1133 of the second type boundary 113, is satisfied, any sport can be applied. In some embodiments, sports, which have relations that a length of a boundary of one sport is an integer multiple of the other sport and at the same time, a length of a boundary of the other sport is an integer multiple of the one sport, can be also applied.

For example, sports such as basketball, foot volleyball, tennis, and futsal may be played in the first type court 111 because those four sports have similar court sizes. If the first type court 111 is designed for volleyball, badminton or table tennis can be played in the second type court 113. That is because volleyball and badminton have a 1:2 compatibility relation, and volleyball and tennis table have a 1:3 compatibility relation.

The invention is not limited to the first type court 111 and the second type court 113 mentioned above. Multiple courts 111, 113, . . . , 11m (m>1) can be applicable according to the same ways, thereby enabling efficient space management. In other words, the first type court 11x (1=<x=<m) can be divided into a plurality of small subordinate courts 11xa along a long direction boundary 11x1 of the first type court 11x at every point that forms integer multiples of a length of the short direction boundary 11y3 of the second type court 11y (1=<y=<m). In this instance, an area size of the subordinate courts 11xa is approximately same as that of the second type court 11y, and thus, the subordinate courts 11xa can be used to play a sport, which the court 11y is for.

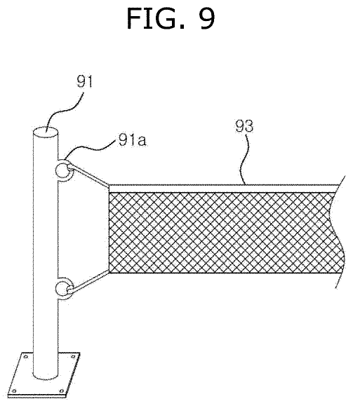

Hereafter, referring to FIGS. 5 and 9, posts 91 for dividing a court and a division mean 93 will be explained. For convenient explanation, two courts 111, 113 will be used to describe the posts 91 and the division mean 93.

For dividing the first type court 111, the multi-sport center may comprise the posts 91 installed along a long direction boundary 11m1 of the first type court 111 at every point that forms integer multiples of a length of the short direction boundary 1133 of the second type court 113.

The posts 91 may be a structure on which nets can be hung. The post 91 may be fixed to the points mentioned above. In this case, the posts 91 are not obstacles to a game and enable a quick, accurate division of the court without time-consuming processes such as calculating locations of posts 91 when the court is required to be divided into a plurality of subordinate courts 111a. Thus, the posts 91 enable convenient rearrangement of the court.

The posts 91 can be categorized into vertex posts 911 installed at vertexes of the court and middle posts 913 installed along long direction boundaries. The division means are engaged with the vertex posts 911 and serve as partitions which allow the first type court 111 to be separated from the neighboring first type court or the passage 3. The middle post 913 may be engaged with the division means 93 only when the first type court is divided into a plurality of subordinate courts 111a and serve as boundaries between the subordinate courts 111a.

The post 91 includes an engagement mean 91a (shown in FIG. 9) installed at one side thereof and is engaged with the division mean 93. The division mean 93 may be a net or any other mean, which can be used for dividing a space.

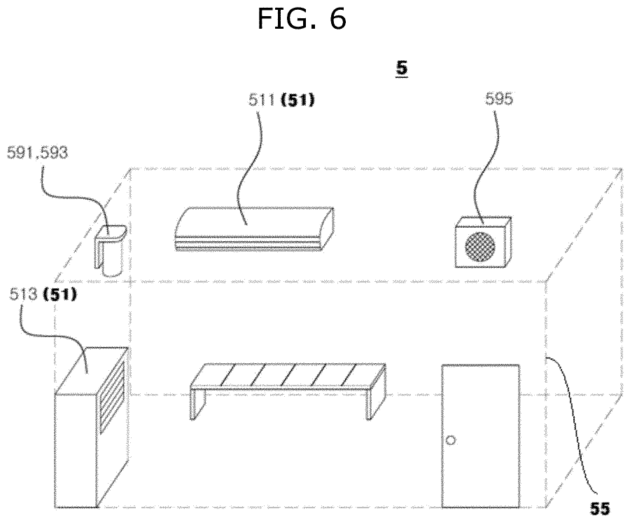

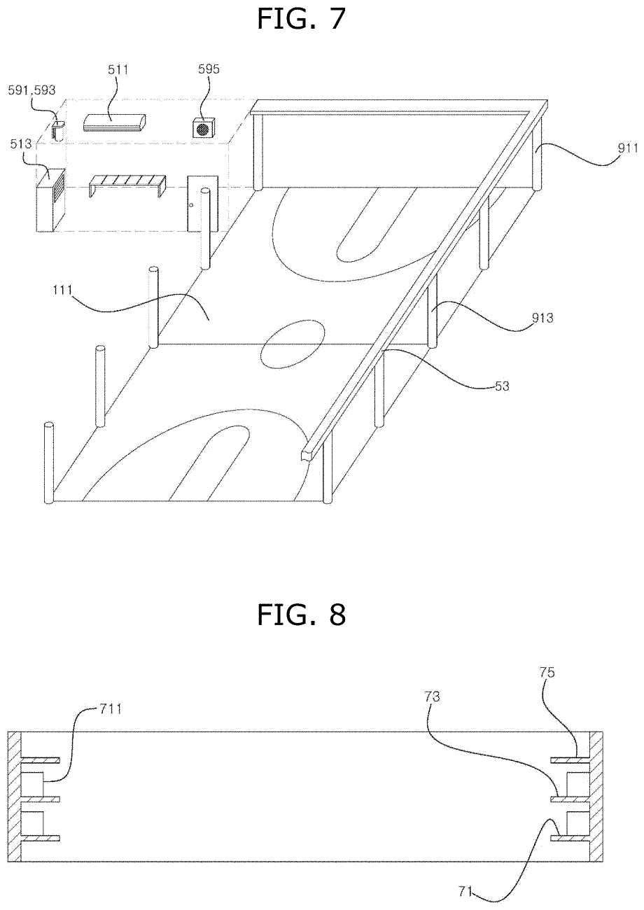

Hereafter, referring to FIGS. 6 and 7, a cooling and heating booth 5, which enables taking a break during exercise, will be explained.

The sector 1 may include the cooling and heating booth 5 installed at one side thereof. In this instance, it is desired that at least one of the booth 5 is installed at every sector 1 and outside boundaries of the sector 1 to avoid disturbance to a game. The booth 5 is a rest space for sport players, who exercise in the court, and this booth 5 enables a cooling and heating system 51 to be operated only in local regions, thereby increasing energy efficiency, preventing waste of energy, and leading to economically advantageous effects. Energy can be saved by turning on the cooling and heating system 51 only in partial space. Sport players can take breaks in pleasant surroundings of this booth 5.

A cooling and heating duct 53 of the cooling and heating system 51 is for communicating to the outside. The cooling and heating duct 53 is installed on a posts 911, 913 formed along edges of each sector, thereby minimizing disturbance to a sport game. The duct 53 also serves as a mean to separate one sector from the other sector and the passage. In this instance, it is desired that the duct 3 is installed at a level that is higher than heights of people so that people can come in and out without inconvenience.

The cooling and heating system 51 comprises an air-conditioner 511 and a heater 513. The air-conditioner 511 may be installed on an upper level portion inside the booth 5, and heater 513 may be installed on a lower level portion inside the booth 5, as necessary. Since cold air from the air-conditioner 511 goes downward, and heated air from the heater 513 goes upward, a cooling and heating efficiency can be increased through this structure.

In addition, the booth 5 includes an air curtain 57, which can prevent cooled or heated air from inflow or outflow, thereby maximizing cooling and heating efficiency. It is desired that walls 55 of the booth 5 are made of transparent materials and players, who are on break, can see other games from the inside of the booth 5.

In this instance, the materials may be glass or polycarbonate. To provide more pleasant surroundings on break, an oxygenator or phytoncide diffusers 591, 593 may be installed inside the booth 5. In addition, the booth 5 may include a speaker 595 for announcement or music and image facilities for showing images or videos. This cooling and heating booth 5 enables high energy efficiency by cooling and heating on local regions with small electricity when compared to prior arts, which requires to cool and heat on the entire space inside a sport facility. Specifically, electricity, which could be saved by this invention, may be calculated as following. First, according to one embodiment of a volume of a multi-sport center of the present invention, the multi-sport center may be assumed that it has at least one court for each of fifteen sports including futsal, foot volleyball, basketball, volleyball, tennis, badminton, table tennis, bowling, screen golf, gate ball, mini tennis, squash, baseball pitcher and batter's box, gym, traditional playground. In this case, the multi-sport center requires 90 m*94 m=8,460 m\hat{ }2 of an area size. In addition, if a height of the sport facility is 20 m, the total volume of the sport center is (8,460 m\hat{ }2)*20 m=169,200 m\hat{ }3. To calculate a volume of a cooling and heating booth 5, the number of booths 5 required for courts will be reviewed first. In this instance, a height of the booth 5 is assumed 2.5 m. A total volume of the booths 5 on the first floor in the sport center is calculated based on an area size of the booth. The booth area size may be calculated based on an area size occupied by one person and the total number of people that is allowed to exercise in the sport facility at a time. Rest spaces on the second and third floor in the sport center is calculated based on the total number of booths on each floor and a booth area size per single booth. In this instance, it can be assumed that 54 booths are installed on each floor. The total number of people, who exercise in 15 sports mentioned above, is 164, and an occupied area of one person sitting in a chair is 1.5 m*1.6 m. Based on these, the total volume of the booths 5 on the first floor is 1.5 m*0.6 m*2.5 m*164=369 m\hat{ }3. The total volume of the booths 5 on the first floor is 0.2% of the entire space inside the sport center. Accordingly, if the booths 5 on the first floor is heated, it has 500 times more heating effects when compared to heating the entire space inside the sport center.

The total volume of the booths on the second and the third volume is 108*1.5 m*2.4 m*2.5 m=972 m\hat{ }3. Accordingly, the total volume of the booths of the first to the third floor is 1341 m\hat{ }3. Therefore, even if all the booths on the first, the second, and the third floor is heated, the cost for heating is only 1% of the cost for heating the entire space. It is obvious that the heating cost can be reduced when only local areas are heated.

In addition, windows on four walls of the sport center are used to adjust temperature and to ventilate. In this case, all window on the first and the fourth floor can be open and closed. On the other hand, half of windows on the second and the third floor are open and closed, and the rest of them are constructed as glass walls.

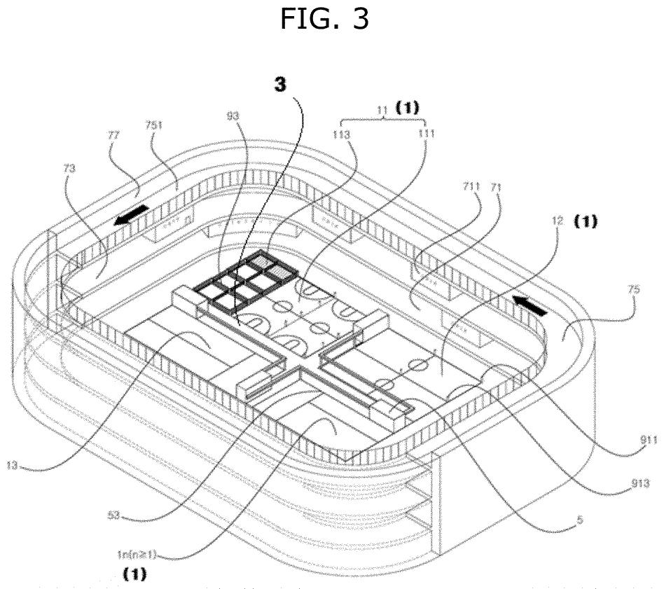

Hereafter, referring to FIGS. 3 and 8, cantilevers 71, 73, installed on an upper portion of the sector 1 will be explained. The multi-sport center may comprise one or more cantilevers 71, 73, 75. The cantilevers 71, 73, 75 are overhung from an inner side of a wall 77 surrounding a space where the sector 1 is located, and spectators can see the sector 1 on the first floor. In this instance, it is desired that the cantilevers 71, 73, 75 are installed at levels that does not disturb a sport game.

According to the invention, stands, which are installed on the second and the third floor in general sport facilities, can be removed, and the cantilevers 71, 73, 75 may include jogging track on one side. General sport facilities are equipped with stands on the second and the third floor; however, sport facility for general citizens do not require stands in quantities. Even though stands are not required, the stands occupy a large portion of the space in the facility, and this prevents the facility from being used for various games.

On the other hand, since the invention includes jogging track instead of stands, people can enjoy jogging without disturbing players, who are in courts 111, 113, etc, and being disturbed from others. Since the cantilever is installed on the upper level, people in the cantilevers 71, 73, 75 can look down games played on the first floor and have a large field of view. Therefore, the invention with the cantilever 71, 73, 75 can provide pleasant jogging surroundings.

The invention may include various recreational facilities, such as a café 711, a snack bar (not shown), a theater (not shown), a media room (not shown), an electronic game room (not shown), a go game room (not shown), a virtual experience room, etc. When people exercise in the courts, they sometimes go out to an external cafeteria to drink or eat on break. The recreational facilities in the invention contributes to the convenience of users. Meanwhile, there are many people who do not exercise but just visit the sport facility along with family or friends who exercise. In general sport facilities, since there is no rest space for visitors other than stands 71b, it causes inconvenience for visitors. Furthermore, when these visitors have tedious waiting for their family or friends who play in games, the players also cannot concentrate on their games. However, according to the invention, all family members can spend time together in this multipurpose sport center. The cantilevers 71, 73, 75 enable to make the best use of the limited space of the sport center.

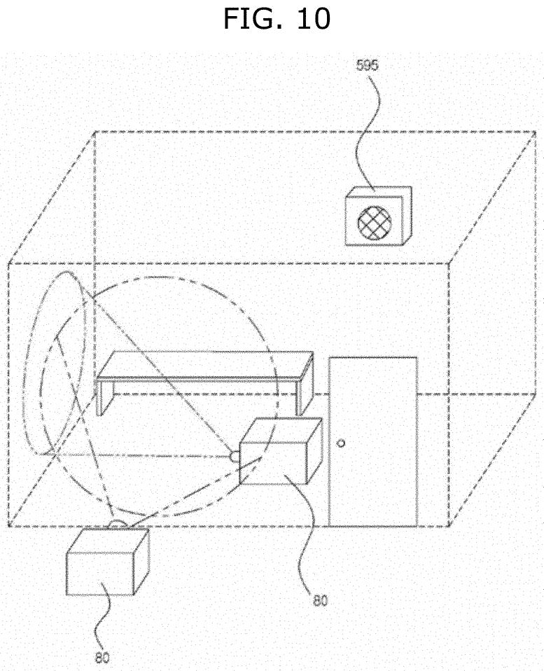

FIG. 10 is a perspective view of a booth according to one embodiment of the present invention.

According to another embodiment of the present invention in FIG. 10, the booth further includes image facilities 80, which display images or videos on an inner side or an outer side of the walls of the booth. In this instance, the images or videos are displayed on the walls with 75% to 85% transparency. The image facilities 80 may retain images or videos of various situations and display them. In addition, the booth may further include a speaker 595 for announcement or music.

The images or videos retained and displayed by the image facilities 80 may include scenes that a coach analyzes and watches a game, or coaches players in real time.

In addition, when a game is stopped, images or videos filmed until before the game is stopped can be displayed by the image facilities. Accordingly, players can analyze and supplement the game using these image facilities.

Furthermore, images or videos of substitute players and instant replays of a game may be displayed in real time. The substitute players can monitor the game using image facilities.

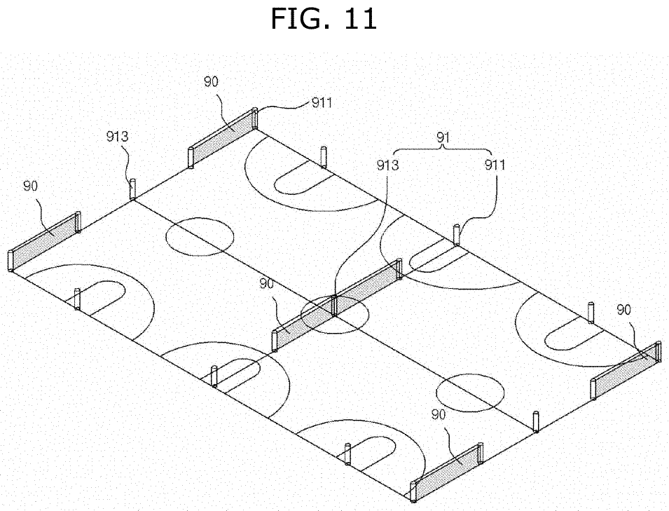

FIG. 11 is a perspective view of a multi-sport facility according to one embodiment of the present invention.

Referring to FIG. 11, the court includes a top side, a bottom side, a left side, and a right side. A center boundary divides the court in the center. The center boundary is formed to be parallel to a short direction boundary, and has a first side facing the top side of the court and a second side facing the bottom side of the court. At least one roll screen module 90, which is spread out from a top to a bottom, may be installed on the top side, the bottom side, the left side, the right side, the first side, and the second side.

The screen module 90 displays scenes including a coach giving demonstrations or instructions. These can be displayed by high quality images or video, 3D images or videos, or hologram image or videos, as necessary.

According to embodiments, the roll screen module 90 is mounted on the post 91 used for division. Specifically, the roll screen module 90 is hung on and fixed to more than one vertex post 911 or/and more than one middle post 913 and has a net shape.

According to the structure described above, the roll screen module 90 installed toward the stands can display game images or videos in real time. In this instance, the height of the roll screen module 90 mounted on the post 91 can be adjusted and fixed. Since a method of adjusting the height of the screen is well known to one skilled in the art, detailed explanation will be omitted.

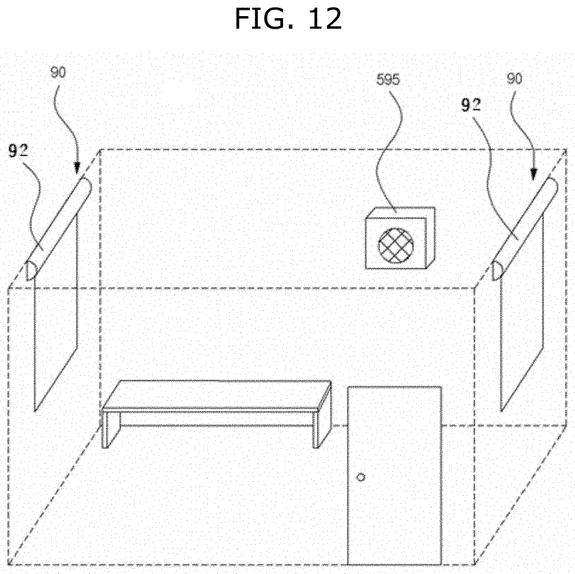

FIG. 12 is a perspective view of a booth according to another embodiment of the present invention.

Referring to FIG. 12, at least one the roll screen module 90 is installed on an inner side or an outer side of the walls of the booth. In addition, the booth may further include a speaker 595 installed on the inner side of the walls for announcement or music. When hologram images or videos are displayed, more than one rail 92, on which the roll screen module is mounted, is installed on the inner side or the outer side of the walls. It is desired that each rail 92 is installed to be parallel and face to each other on both sides of a center of the booth.

Embodiments of the present invention described above are to be considered illustrative, and the scope of the present invention shall not be restricted or limited by the foregoing description. It would be apparent that many more modifications and variations than mentioned above are possible by an ordinary person skilled in the art within scopes of appended claims.

The appended claims are intended to cover all such modifications, enhancements, and other embodiments, which fall within the true spirit and scope of the inventive concept.

What is claimed is:

1. A multi-sport center comprising:
sectors used for various sport games, and
a passage separating the sectors that are adjacent to each other,
wherein each sector includes courts having court boundaries and partitioned for each sport, the court boundaries of each court is formed according to court standards of sports whose courts are inter-compatible to each other, and the courts that are adjacent to each other are inter-compatible, thereby increasing management efficiency of the multi-sport center.

2. The multi-sport center of claim 1, wherein the court boundaries include a long direction boundary and a short direction boundary that is shorter than the long direction boundary.

3. The multi-sport center of claim 2, wherein a long direction boundary of a first type court of a given court of the courts is formed to be an integer multiple of a short direction boundary of a second type court of the given court.

4. The multi-sport center of claim 3, wherein the courts further include posts installed along the long direction boundary to separate the courts.

5. The multi-sport center of claim 3, wherein the post includes:
vertex posts installed at vertexes of each court, and
middle posts installed along the long direction boundary at every point that forms integer multiples of a length of the short direction boundary of the second type.

6. The multi-sport center of claim 5, further comprising an engagement mean connecting between the middle posts each installed at the long direction boundaries that face to each other, thereby dividing the first type court into multiple subordinate courts,
wherein the multiple subordinate courts formed by the engagement mean meet standard requirements of the second type court.

7. The multi-sport center of claim 1, further comprising more than one cooling and heating booth installed at one side of each sector and helping players in each court to take breaks.

8. The multi-sport center of claim 7, wherein the cooling and heating booth includes a duct, and the duct is mounted on the posts to avoid disturbance to a sport game.

9. The multi-sport center of claim 7, wherein the cooling and heating booth is made of transparent materials, thereby enabling people to see sport games from the inside of the booth.

10. The multi-sport center of claim 7, further comprising more than one cantilever overhung from an inner side of a wall surrounding a space where the sectors are located,
wherein the cantilever is installed at a level that does not disturb sport games.

11. The multi-sport center of claim 10, wherein one side of the cantilever includes jogging track.

12. The multi-sport center of clam 10, wherein one side of the cantilever includes at least one of café, a snack bar, a theater, a media room, an electronic game room, a go game room, and a virtual experience room, thereby enabling family to spend a time together.

13. The multi-sport center of claim 9, further comprising image facilities that display images or videos with 75% to 85% transparency on an inner side or an outer side of the wall of the booth,
wherein the image facilities display:
images or videos including scenes that a coach analyzes and watches a sport game in the court, or coaches players of the game in real time,
images or videos of the game that is filmed until before the game is stopped, and
images or videos of substitute players for the game and instant replays of the game in real time.

14. The multi-sport center of claim 9, wherein the court includes a top side, a bottom side, a left side, and a right side,
wherein a center boundary divides the court in the center, the center boundary is formed to be parallel to the short direction boundary, and includes a first side facing the top side of the court and a second side facing the bottom side of the court,
wherein at least one roll screen module that is spread out from a top to a bottom is installed on the top side, the bottom side, the left side, the right side, the first side, and the second side.

15. The multi-sport center of claim 14, wherein the screen module displays scenes including a coach giving demonstrations or instructions using high quality images or video, 3D images or videos, or hologram image or videos, as necessary.

16. The multi-sport center of claim 15, wherein the roll screen module is hung on and fixed to more than one vertex post or/and more than one middle post and has a net shape.

17. The multi-sport center of claim 15, wherein when the hologram images or videos are displayed, more than one rail, on which the roll screen module is mounted, is installed on the inner side or the outer side of the wall, and the rail is installed to be parallel and face to each other on both sides of a center of the booth.
